(19) United States
(12) Patent Application Publication
(10) Pub. No.: US 2023/0283804 A1
(43) Pub. Date: Sep. 7, 2023

(54) COMPUTER-READABLE RECORDING MEDIUM STORING TRANSMISSION PROGRAM, TRANSMISSION APPARATUS, AND TRANSMISSION METHOD

(71) Applicant: Fujitsu Limited, Kawasaki-shi (JP)

(72) Inventors: Kotaro SHIIZAKI, Kawasaki (JP); Akihiro WADA, Kawasaki (JP); Tatsuya KIKUZUKI, Kawasaki (JP); Teruhisa NINOMIYA, Yokohama (JP); Kaoru YOKOO, Yokosuka (JP); KOHJI YAMADA, Kawasaki (JP)

(73) Assignee: Fujitsu Limited, Kawasaki-shi (JP)

(21) Appl. No.: 18/068,835

(22) Filed: Dec. 20, 2022

(30) Foreign Application Priority Data
Mar. 2, 2022 (JP) 2022-031669

(51) Int. Cl. H04N 19/593; H04N 19/177

(52) U.S. Cl. CPC H04N 19/593; H04N 19/177

(57) ABSTRACT

A non-transitory computer-readable recording medium storing a transmission program causing a computer of a first transmission apparatus to execute a procedure, the procedure includes detecting a collision between a transmission timing of an intra-coded video frame in first video data transmitted from the first transmission apparatus and a transmission timing of an intra-coded video frame in second video data transmitted from a second transmission apparatus, changing, when the collision is detected at a first time, a frame type of the first video data to one of a forward predictive coded video frame and a bi-directional predictive coded video frame, and transmitting the first video data of which the frame type is changed, at a second time at which the intra-coded video frame in the first video data is scheduled to be transmitted.

### CROSS-REFERENCE TO RELATED APPLICATION

This application is based upon and claims the benefit of priority of the prior Japanese Patent Application No. 2022-31669, filed on Mar. 2, 2022, the entire contents of which are incorporated herein by reference.

### FIELD

The embodiments discussed herein are related to a computer-readable recording medium storing a transmission program, a transmission apparatus, and a transmission method.

### BACKGROUND

In recent years, along with popularization of high-speed wireless technologies, demand for wireless video transmission in which a high-speed wireless technology and a video compression technology are combined has been increasing. For example, wireless transmission of a field video in a factory or the like, video posting in a mobile environment by a person, and the like are performed.

In the video compression technology, an intra-coded (I) frame, a predictive coded (P) frame, and a bi-directional predictive coded (B) frame have been introduced in a video encoding method of a moving picture experts group (MPEG) internationally standardized by International Standards Organization/International Electrotechnical Commission (ISO/IEC).

As a related technology, for example, a technology has been proposed in which an attention degree is estimated for each of unit regions obtained by dividing a frame plane, and a moving image is compression-encoded by differentiating a compression rate for each of the unit regions based on a distribution of the attention degree.

Japanese Laid-open Patent Publication No. 2021-057770 is disclosed as related art.

### SUMMARY

According to an aspect of the embodiments, a non-transitory computer-readable recording medium storing a transmission program causing a computer of a first transmission apparatus to execute a procedure, the procedure includes detecting a collision between a transmission timing of an intra-coded video frame in first video data transmitted from the first transmission apparatus and a transmission timing of an intra-coded video frame in second video data transmitted from a second transmission apparatus, changing, when the collision is detected at a first time, a frame type of the first video data to one of a forward predictive coded video frame and a bi-directional predictive coded video frame, and transmitting the first video data of which the frame type is changed, at a second time at which the intra-coded video frame in the first video data is scheduled to be transmitted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an example of a transmission apparatus;

FIG. 2 is a diagram illustrating an example of a configuration of a transmission system;

FIG. 3 is a diagram illustrating an example of a hardware configuration of a transmission apparatus;

FIG. 4 is a diagram illustrating an example of a group of pictures (GOP);

FIG. 5 is a diagram illustrating an example of band pressure at a time of a collision between I-frame transmission timings;

FIG. 6 is a diagram illustrating an example of a configuration of a transmission system;

FIG. 7 is a diagram illustrating an example of a change of an I-frame transmission timing and reconstruction of a GOP;

FIG. 8 is a flowchart illustrating an example of an operation of a transmission apparatus;

FIG. 9 is a diagram illustrating an example of periodicity of a network band usage;

FIG. 10 is a diagram illustrating an example of a configuration of a transmission system;

FIG. 11 is a flowchart illustrating an example of an operation of a transmission apparatus;

FIG. 12 is a diagram illustrating an example of a configuration of a transmission system;

FIG. 13 is a flowchart illustrating an example of an operation of a transmission apparatus;

FIG. 14 is a flowchart illustrating an example of an operation of a transmission apparatus;

FIG. 15 is a diagram illustrating an example of a broadcast for indicating an offset time;

FIG. 16 is a diagram illustrating an example of a configuration of a transmission system; and

FIG. 17 is a flowchart illustrating an example of an operation of a transmission apparatus.

### DESCRIPTION OF EMBODIMENTS

Among the video frames, the I-frame is a frame that is independently decodable, and thus has a large amount of information, and a size of the I-frame is larger than a size of the P-frame or the B-frame. For this reason, in a case where transmission timings of the I-frames collide with each other when video frames are wirelessly transmitted by a plurality of transmission apparatuses, traffic is pressured in a radio band in which the transmission timings of the I-frames collide with each other, and thus there is a problem in that a transmission delay of the video occurs.

Hereinafter, embodiments of techniques capable to suppress the transmission delay of the video are described with reference to the drawings.

### First Embodiment

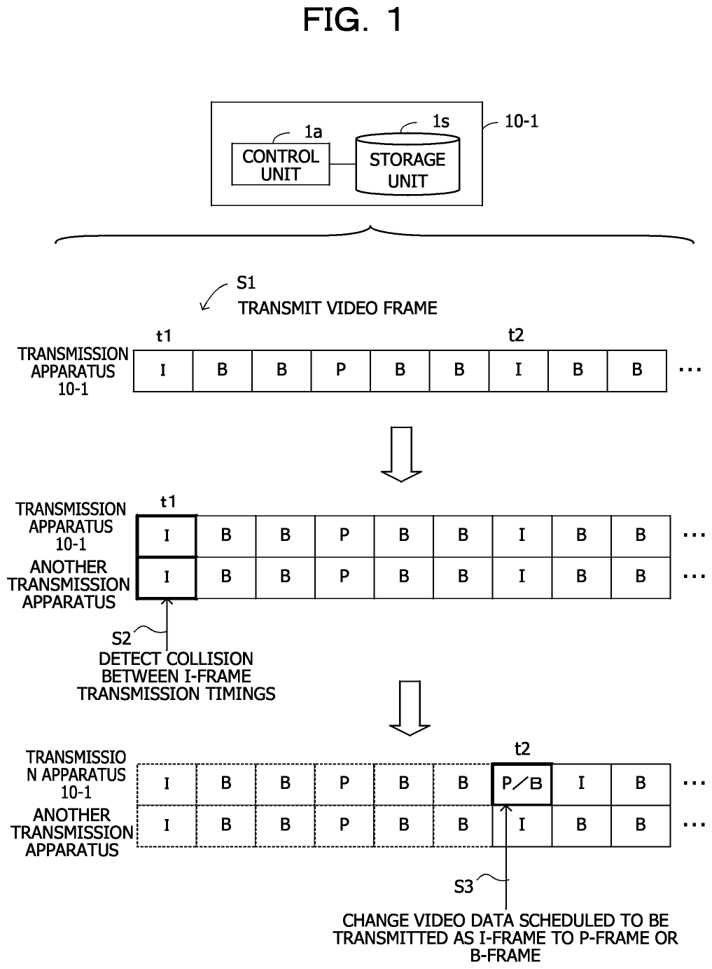

FIG. 1 is a diagram for describing an example of a transmission apparatus. A transmission apparatus 10-1 is an apparatus that includes a control unit 1a and a storage unit 1s and performs wireless transmission of a video. For example, a function of the control unit 1a is implemented by a processor (not illustrated) included in the transmission apparatus 10-1 executing a predetermined program. The storage unit 1s is used as a main storage apparatus of the transmission apparatus 10-1 and stores, for example, video data or the like captured by a camera.

[Operation S1] The control unit 1a encodes video data to generate an I-frame (intra-coded video frame), a P-frame (forward predictive coded video frame), and a B-frame (bi-directional predictive coded video frame), and transmits each video frame at a predetermined period.

In this case, the control unit 1a generates a group in which the I-frame is set as a head and the B-frame is inserted between the I-frame and the P-frame or between the P-frame and the I-frame (for example, IBBPBBIBB . . . ).

A set of frames with the I-frame as a head is referred to as a group of pictures (GOP). It is assumed that the I-frame obtained by performing intra-coding on the video data is transmitted at times t1 and t2.

[Operation S2] The control unit 1a detects a collision (overlap of I-frame transmission timings) between a transmission timing of the I-frame in the video data transmitted from the transmission apparatus 10-1 and a transmission timing of an I-frame in video data transmitted from another transmission apparatus. It is assumed that the control unit 1a detects a collision between I-frame transmission timings at time t1.

An arrangement of I-, B-, P-frames transmitted from the transmission apparatus 10-1 and an arrangement of I-, B-, P-frames transmitted from the other transmission apparatus are the same (at least the transmission timing of the I-frame is common to the transmission apparatus 10-1 and the other transmission apparatus).

[Operation S3] In a case where the collision between the I-frame transmission timings is detected at time t1, the control unit 1a changes a frame type of the video data to the P-frame or the B-frame and transmits the video data at time t2 at which the I-frame is scheduled to be transmitted thereafter.

As described above, when the transmission apparatus 10-1 detects the collision between the I-frame transmission timings with the other transmission apparatus at time t1, the transmission apparatus 10-1 changes the frame type of the video data to the P-frame or the B-frame and transmits the video data at time t2 at which the I-frame is scheduled to be transmitted thereafter. Accordingly, it is possible to reduce the collision between the I-frame transmission timings and to suppress the transmission delay of the video.

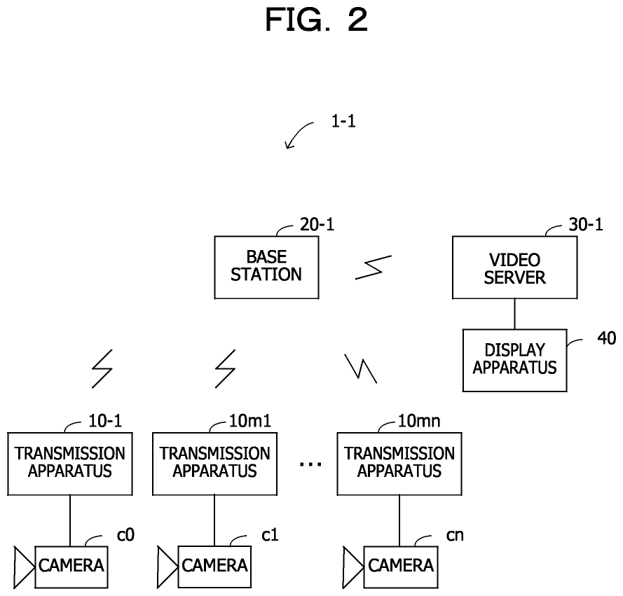

FIG. 2 is a diagram illustrating an example of a configuration of a transmission system. A transmission system 1-1 includes the transmission apparatus 10-1, transmission apparatuses 10m1, . . . , and 10mn, a base station (or an access point) 20-1, and a video server 30-1.

The transmission apparatuses 10m1, . . . , and 10mn are apparatuses that perform video transmission in the same manner as the transmission apparatus 10-1, and the transmission apparatus 10-1, the transmission apparatuses 10m1, . . . , and 10mn, and the video server 30-1 are wirelessly coupled to each other via the base station 20-1.

The transmission apparatus 10-1 and the transmission apparatuses 10-1, 10m1, . . . , and 10mn respectively include cameras c0, c1, . . . , and cn, each encode a video captured by a corresponding one of the cameras c0, c1, . . . , and cn, and each transmit the encoded video to the base station 20-1. The camera video transmitted to the base station 20-1 is transmitted to the video server 30-1, decoded by the video server 30-1, and displayed on a display apparatus 40 coupled to the video server 30-1.

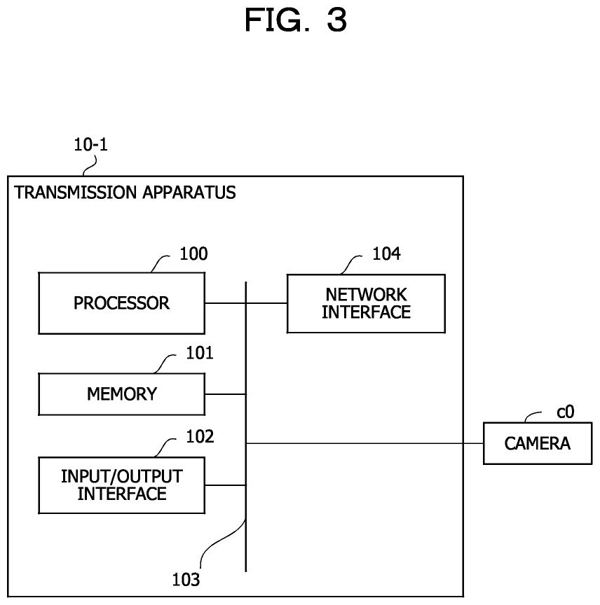

FIG. 3 is a diagram illustrating an example of a hardware configuration of the transmission apparatus. A processor 100 controls the entire transmission apparatus 10-1. The processor 100 implements a function of the control unit 1a.

A memory 101, an input/output interface 102, and a network interface 104 are coupled to the processor 100 via a bus 103. The camera c0 is externally attached to the transmission apparatus 10-1, and the camera c0 is coupled to the bus 103.

The processor 100 may be a multiprocessor. For example, the processor 100 is a central processing unit (CPU), a field-programmable gate array (FPGA), a microprocessor unit (MPU), a digital signal processor (DSP), an application-specific integrated circuit (ASIC), or a programmable logic device (PLD). Alternatively, the processor 100 may be a combination of two or more elements of the CPU, the FPGA, the MPU, the DSP, the ASIC, and the PLD.

The memory 101 implements a function of the storage unit 1s and is used as a main storage apparatus of the transmission apparatus 10-1. The memory 101 temporarily stores video data captured by the camera c0 and at least a part of an operating system (OS) program and application programs to be executed by the processor 100. The memory 101 also stores various types of data used in processing by the processor 100.

The memory 101 is also used as an auxiliary storage apparatus of the transmission apparatus 10-1 and stores the OS program, the application programs, and the various types of data. The memory 101 may include a semiconductor storage apparatus such as a flash memory and a solid-state drive (SSD), or a magnetic recording medium such as a hard disk drive (HDD), as the auxiliary storage apparatus.

The input/output interface 102 and the network interface 104 may be coupled to the bus 103. The input/output interface 102 may be coupled to an information input apparatus such as a keyboard and a mouse. The input/output interface 102 transmits a signal transmitted from the information input apparatus to the processor 100.

The input/output interface 102 also functions as a communication interface for coupling with peripheral devices. For example, an optical drive apparatus that uses laser light or the like to read data recorded on an optical disk may be coupled to the input/output interface 102. Examples of the optical disk include a Blu-ray Disc (registered trademark), a compact disc read-only memory (CD-ROM), a CD-recordable (R)/rewritable (RW), and the like.

A memory apparatus and a memory reader/writer may be coupled to the input/output interface 102. The memory apparatus is a recording medium having the function of communicating with the input/output interface 102. The memory reader/writer is an apparatus that writes data to a memory card or reads data from the memory card. The memory card is a card-type recording medium.

The network interface 104 is coupled to a network and performs network interface control. For example, a network interface card (NIC), a wireless local area network (LAN) card, or the like may be used as the network interface 104. Data received by the network interface 104 is output to the memory 101 or the processor 100.

With the hardware configuration as described above, a processing function of the transmission apparatus 10-1 may be implemented. For example, the transmission apparatus 10-1 may perform processing of the embodiment of the present disclosure by the processor 100 executing each predetermined program.

For example, the transmission apparatus 10-1 implements the processing function of the embodiment of the present disclosure by executing a program recorded in a computer-readable recording medium. A program describing a content of processing executed by the transmission apparatus 10-1 may be recorded in various recording media.

For example, the program to be executed by the transmission apparatus 10-1 may be stored in the auxiliary storage apparatus. The processor 100 loads at least a part of the program in the auxiliary storage apparatus into the main storage apparatus and executes the program.

The program may be recorded in a portable-type recording medium such as an optical disk, a memory apparatus, or a memory card. The program stored in the portable-type recording medium may be executed, for example, under the control of the processor 100 after being installed in the auxiliary storage apparatus. The processor 100 may read the program directly from the portable-type recording medium and execute the program. A hardware configuration similar to that illustrated in FIG. 3 may be applied to other transmission apparatuses (transmission apparatuses 10m1, . . . , and 10mn).

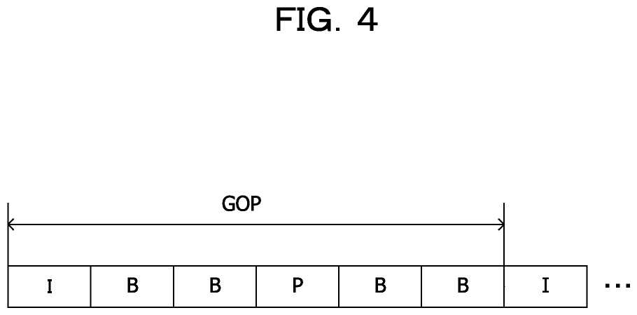

FIG. 4 is a diagram illustrating an example of a GOP. The GOP is a set of frames including at least one I-frame in the video compression technology of MPEG, and the GOP is configured with the I-frame as a head.

The GOP includes an I-frame, B-frames, and a P-frame. The I-frame is a frame that has no dependency relationship with other frames and may be decoded alone. The B-frame is a frame obtained by encoding a difference from data predicted from both the past and future frames. The P-frame is a frame obtained by encoding a difference from data predicted from a past frame.

The I-frame is characterized in that the I-frame may be decoded alone but has a large amount of information and the size thereof is larger than that of the P-frame or the B-frame. The I-frame is also characterized in that the I-frame is periodically inserted into the GOP but the insertion frequency thereof is lower than those of the P-frame and the B-frame.

Although FIG. 4 illustrates an example in which the GOP is configured with I, B, B, P, B, and B, a ratio of the B-frames in one GOP is increased in a case where the compression rate is to be increased, and a ratio of the P-frames in one GOP is increased in a case where image quality is to be emphasized.

It is assumed that, at the time of normal operation before the frame type is changed, the arrangement of the B-frame and the P-frame after the I-frame is common to each transmission apparatus (at least the transmission timing of the I-frame is common to each transmission apparatus).

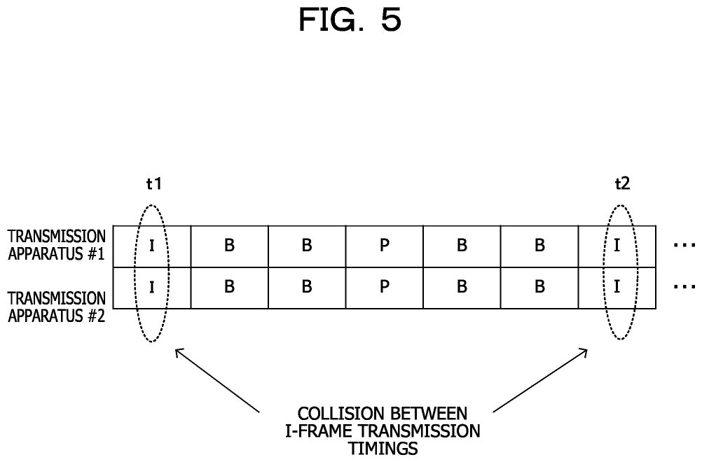

FIG. 5 is a diagram illustrating an example of band pressure at a time of a collision between I-frame transmission timings. Transmission apparatuses #1 and #2 that perform MPEG video compression and transmit video frames encode video data in order of I, B, B, P, B, B, I, . . . and transmit the video frames.

The video frames periodically transmitted by the transmission apparatuses #1 and #2 at times t1, t2, . . . are I-frames, and the arrangement of the I-, B-, and P-frames in the transmission apparatuses #1 and #2 are the same. It is assumed that the transmission timings of the I-frames collide with each other at times t1 and t2.

In such a case, since the size of the I-frame is larger than the size of the P-frame or the B-frame, at times t1 and t2 when the transmission timings of the I-frames collide with each other, radio band traffic is pressured, and a phenomenon occurs in which a transmission delay occurs and transmission efficiency decreases.

In consideration of such a point, the transmission apparatus 10-1 implements transmission control in which the collision between the I-frame transmission timings is reduced to suppress the transmission delay of the video by the control as illustrated in FIG. 1.

### Second Embodiment

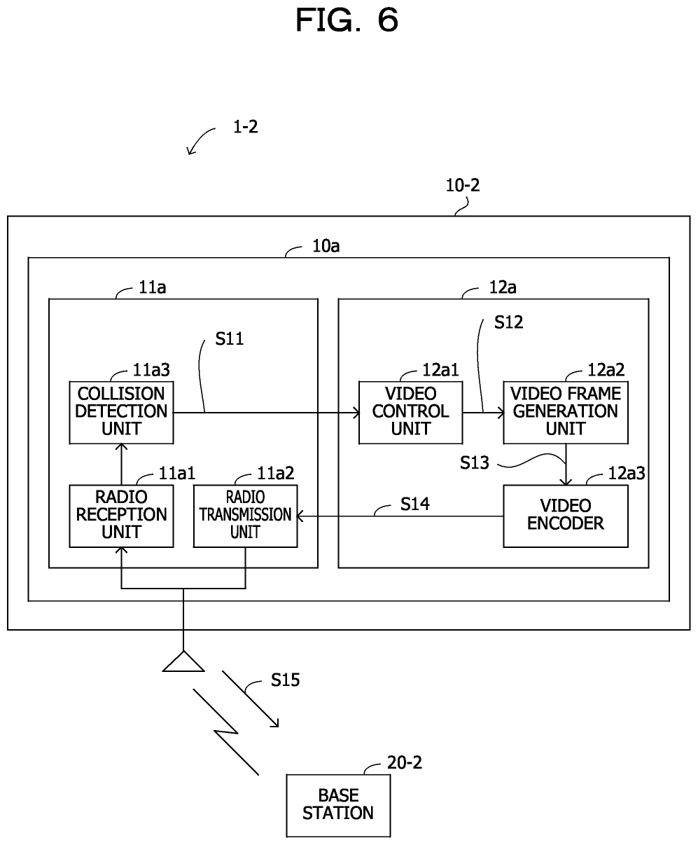

FIG. 6 is a diagram illustrating an example of a configuration of a transmission system. A transmission system 1-2 includes a transmission apparatus 10-2 and a base station 20-2. The transmission apparatus 10-2 includes a control unit 10a. The control unit 10a includes a radio unit 11a and a video unit 12a. The radio unit 11a includes a radio reception unit 11a1, a radio transmission unit 11a2, and a collision detection unit 11a3. The video unit 12a includes a video control unit 12a1, a video frame generation unit 12a2, and a video encoder 12a3.

[Operation S11] The collision detection unit 11a3 outputs collision information when a collision between I-frame transmission timings is detected from information such as a reception electric field intensity received by the radio reception unit 11a1.

[Operation S12] When the collision information is received, the video control unit 12a1 determines that the frame type of the video data scheduled to be transmitted as the I-frame is to be changed to the P-frame or the B-frame, and determines a new transmission timing of the I-frame. At the determined transmission timing of the I-frame, the video control unit 12a1 generates and outputs instruction information for reconstructing the GOP with the I-frame as a head.

[Operation S13] The video frame generation unit 12a2 generates a video frame by, for example, framing a camera video captured by a camera.

[Operation S14] The video encoder 12a3 encodes the video frame based on the instruction information, and transmits the encoded video frame (video frame of the reconstructed GOP) to the radio transmission unit 11a2.

In the encoding, the video frame is encoded based on the instruction information. For example, in a case where the instruction information indicates that the frame type at a predetermined time is an I-frame, intra-coding processing is performed on the video frame output from the video frame generation unit 12a2. In the encoding, a frame is divided into macroblocks that are basic processing units, and performs encoding of the video frame while switching, for each of the macroblocks, between intra-coding (intra-frame prediction) using spatial redundancy in the frame and inter-frame prediction using temporal redundancy between frames to generate an I-frame, a P-frame, or a B-frame.

[Operation S15] The radio transmission unit 11a2 converts the video frame into a radio signal and transmits the radio signal to the base station 20-2.

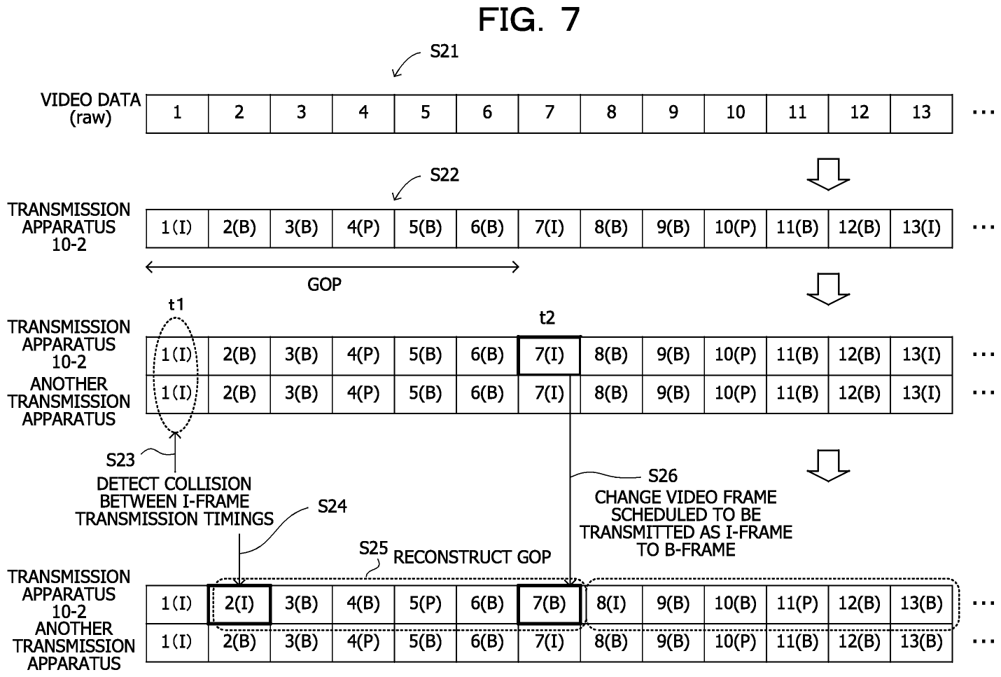

FIG. 7 is a diagram illustrating an example of a change of the I-frame transmission timing and reconstruction of the GOP.

[Operation S21] The control unit 10a of the transmission apparatus 10-2 receives video data captured by a camera. The camera video includes pieces of video data 1, . . . , 13, . . . , and the pieces of video data 1, . . . , and 13, . . . are arranged in order in a time axis direction.

[Operation S22] The control unit 10a generates a video frame by framing and encoding each of the pieces of video data, converts the generated video frame into a radio signal, and transmits the radio signal. It is assumed that six video frames configure one GOP. It is assumed that one GOP includes video frames arranged in I, B, B, P, B, and B in the time axis direction.

In the example of FIG. 7, the control unit 10a converts a piece of video data 1 into an I-frame to generate a video frame 1(I). The control unit 10a converts pieces of video data 2, 3, 5, and 6 into B-frames to generate video frames 2(B), 3(B), 5(B), and 6(B), and converts a piece of video data 4 into a P-frame to generate a video frame 4(P).

Similarly, the control unit 10a converts pieces of video data 7 and 13 into the I-frames to generate a video frame 7(I) and a video frame 13(I). The control unit 10a converts pieces of video data 8, 9, 11, and 12 into the B-frames to generate video frames 8(B), 9(B), 11(B), and 12(B), and converts a piece of video data 10 into the P-frame to generate a video frame 10(P).

Operation S22 indicates a normal frame pattern in a case where there is no collision between the I-frame transmission timings, and in a case where a collision between the I-frame transmission timings is detected, for example, it becomes the frame pattern indicated after operation S24.

[Operation S23] The control unit 10a detects a collision between the transmission timing of the I-frame transmitted from the transmission apparatus 10-2 and the transmission timing of the I-frame transmitted from another transmission apparatus. It is assumed that the control unit 10a detects a collision between the I-frame transmission timings at time t1.

[Operation S24] The control unit 10a generates a video frame 2(I) by changing a frame type of the video data 2 to the I-frame.

[Operation S25] The control unit 10a reconstructs the GOP with the changed I-frame (video frame 2(I)) as a head.

For example, in this example, video frames 3(B), 4(B), 6(B), and 7(B) are generated by converting the pieces of video data 3, 4, 6, and 7 into the B-frames, and a video frame 5(P) is generated by converting the piece of video data 5 into the P-frame.

[Operation S26] When the control unit 10a detects a collision between the transmission timings of the I-frames at time t1, the control unit 10a changes a frame type of the video data to the P-frame or the B-frame and transmits the video data at time t2 at which the I-frame is scheduled to be transmitted thereafter. In the example illustrated in FIG. 7, the video frame 7(B) is generated by changing a frame type of the video data 7 to the B-frame.

The reconstructed GOP follows the video frame 7(B). For example, the control unit 10a converts the piece of video data 8 into the I-frame to generate a video frame 8(I), converts the pieces of video data 9, 10, 12, and 13 into the B-frames to generate video frames 9(B), 10(B), 12(B), and 13(B), and converts the piece of video data 11 into the P-frame to generate a video frame 11(P).

As described above, when the transmission apparatus 10-2 detects a collision between the I-frame transmission timings with another transmission apparatus, the transmission apparatus 10-2 changes a frame type of the video data scheduled to be transmitted as the I-frame thereafter to the P-frame or the B-frame and transmits the video data. In accordance with the change in the frame type, the transmission apparatus 10-2 changes the transmission timing of the I-frame. For example, in FIG. 7, in the transmission apparatus 10-2, the I-frame having a seventh transmission timing is changed to the I-frame having an eighth transmission timing. The transmission apparatus 10-2 reconstructs the GOP with the changed I-frame as a head.

Accordingly, an influence of the collision between the I-frame transmission timings may be minimized (only the collision at time t1 in the example of FIG. 7), and the video transmission with the suppressed delay may be performed. Since the transmission timing of the I-frame is not changed by buffering of the video frame, unnecessary delay does not occur, and stable video transmission in which the collision between the transmission timings of the I-frames is reduced may be performed even in an application sensitive to a delay. A frame buffer or the like for changing the I-frame transmission timing is not demanded, and an increase in a circuit size may be suppressed.

A condition for changing the frame type of the video data scheduled to be transmitted as the I-frame to either the P-frame or the B-frame will be described.

A frame size is different between the P-frame and the B-frame, and the former is larger than the latter. By contrast, when the B-frame is decoded, since difference information from previous and subsequent frames is used, in a case where one of the previous and subsequent frames is lost, decoding may be difficult.

For this reason, when it is desired to increase the compression rate, the frame type is changed to the B-frame, and when it is desired to emphasize the image quality, the frame type is changed to the P-frame. For example, in a case where the compression rate after the change of the frame type is to be increased than the compression rate before the change of the frame type, the control unit 10a changes the frame type to the B-frame. In a case where the image quality after the change of the frame type is not to be decreased than the image quality before the change of the frame type, the control unit 10a changes the frame type to the P-frame. Whether the compression rate or the image quality is emphasized depends on, for example, a system design or a user's request.

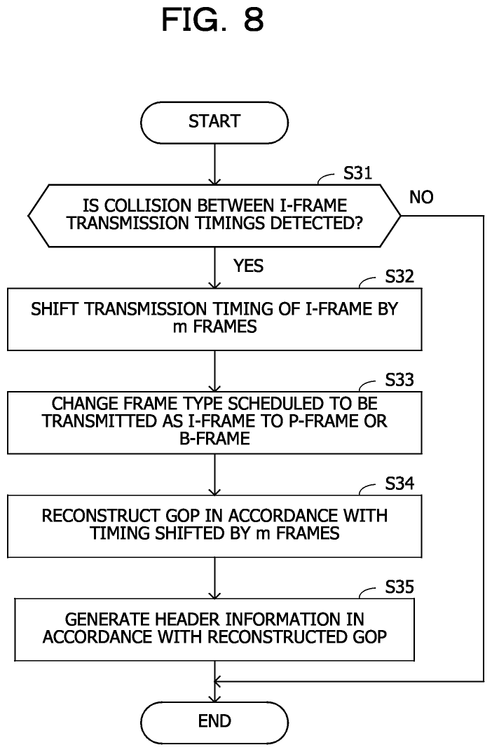

FIG. 8 is a flowchart illustrating an example of an operation of the transmission apparatus.

[Operation S31] The control unit 10a determines whether a collision between the I-frame transmission timings is detected. In a case where a collision is detected, the processing proceeds to operation S32, and in a case where a collision is not detected, the processing ends.

[Operation S32] The control unit 10a changes the transmission timing of the I-frame, and shifts the transmission timing of the I-frame by m frames.

[Operation S33] The control unit 10a changes a frame type of the video data scheduled to be transmitted as the I-frame to the P-frame or the B-frame.

[Operation S34] The control unit 10a reconstructs the GOP in accordance with the timing shifted by m frames.

[Operation S35] The control unit 10a generates and adds header information (GOP header information) in accordance with the reconstructed GOP.

The GOP header information is added before the I-frame that is a head of the GOP. The GOP header information has field information called a group start code, a time code, a closed gop, and a broken link.

The group start code is information for taking a fixed value (hexadecimal 000001B8) and identifying the start of the GOP header. The time code is information to be used for synchronization between video and audio. Each of the closed gop and the broken link is information for indicating, to the decoder, whether first continuous B-frames following immediately after the I-frame may be appropriately reproduced at the time of random access.

### Third Embodiment

A third embodiment will be described next. According to the third embodiment, the I-frame transmission timing is changed and set based on the periodicity of a network band usage.

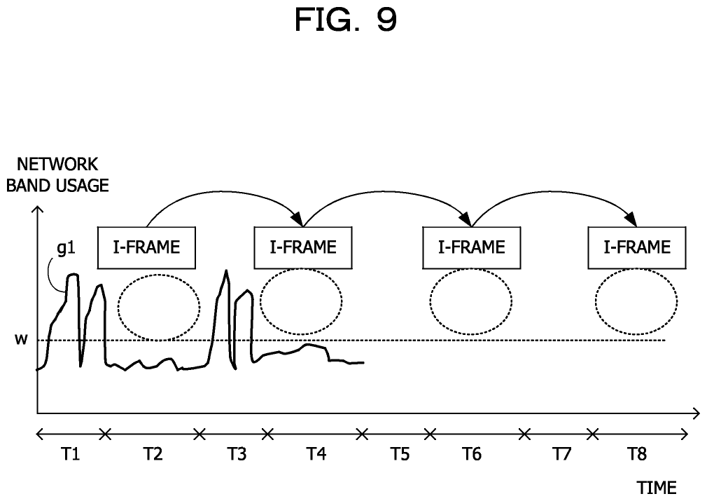

FIG. 9 is a diagram illustrating an example of the periodicity of a network band usage. A vertical axis indicates the network band usage, a horizontal axis indicates a time, and a graph g1 indicates a change in the network band usage in wireless network communication between a base station and a transmission apparatus.

In the graph g1, the network band usage is equal to or greater than a predetermined value w in time slots T1 and T3, the network band usage is less than the predetermined value w in time slots T2 and T4, and the network band usage in the time slots T2 and T4 is lower than that in the time slots T1 and T3.

As described above, in a case where the network band usage has periodicity, it may be estimated from the periodicity of the network band usage that the network band usage in time slots T6 and T8 after the time slot T4 is lower than that in time slots T5 and T7 in the same manner.

Accordingly, in a case where the transmission apparatus detects the collision between the I-frame transmission timings and changes the I-frame transmission timing, the transmission apparatus changes the transmission timing such that the I-frame is transmitted in a time slot in which the network band usage is less than the predetermined value w, based on the periodicity of the network band usage.

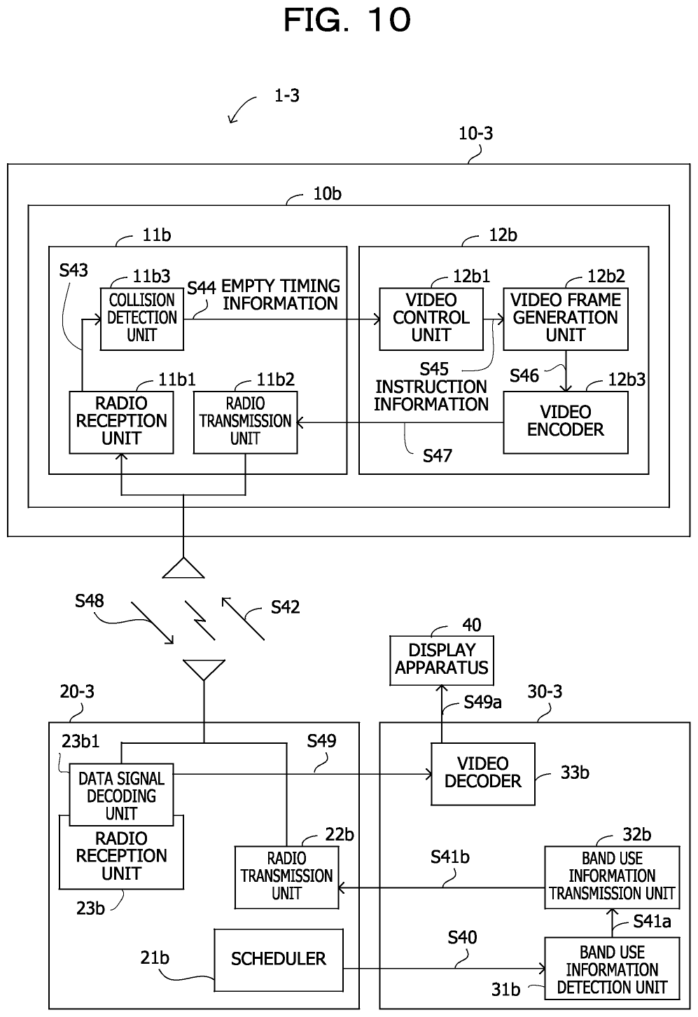

FIG. 10 is a diagram illustrating an example of a configuration of a transmission system. A transmission system 1-3 includes a transmission apparatus 10-3, a base station 20-3, and a video server 30-3.

The transmission apparatus 10-3 includes a control unit 10b, and the control unit 10b includes a radio unit 11b and a video unit 12b. The radio unit 11b includes a radio reception unit 11b1, a radio transmission unit 11b2, and a collision detection unit 11b3. The video unit 12b includes a video control unit 12b1, a video frame generation unit 12b2, and a video encoder 12b3.

The base station 20-3 includes a scheduler 21b, a radio transmission unit 22b, and a radio reception unit 23b, and the radio reception unit 23b has a function of a data signal decoding unit 23b1. The video server 30-3 includes a band use information detection unit 31b, a band use information transmission unit 32b, and a video decoder 33b.

[Operation S40] The scheduler 21b transmits network band information to the video server 30-3.

[Operation S41a] The band use information detection unit 31b detects band use information related to the network band usage of the transmission apparatus 10-3 from the network band information transmitted from the base station 20-3, and outputs the detected band use information.

[Operation S41b] The band use information transmission unit 32b transmits the band use information to the radio transmission unit 22b of the base station 20-3.

[Operation S42] The radio transmission unit 22b converts the band use information into a radio signal and transmits the radio signal to the transmission apparatus 10-3.

[Operation S43] The radio reception unit 11b1 of the transmission apparatus 10-3 converts the band use information transmitted from the base station 20-3 into an electric signal, and outputs the band use information after the conversion into the electric signal.

[Operation S44] The collision detection unit 11b3 outputs collision information when a collision between the I-frame transmission timings is detected from information such as a reception electric field intensity received by the radio reception unit 11b1. The collision detection unit 11b3 detects an empty timing that is a time slot in which the network band usage is less than a predetermined value among the received band use information, and generates and outputs empty timing information.

[Operation S45] When the video control unit 12b1 recognizes the collision between the I-frame transmission timings based on the collision information, the video control unit 12b1 determines that a frame type of the video data scheduled to be transmitted as the I-frame is to be changed to the P-frame or the B-frame, and newly determines a transmission timing of the I-frame based on the empty timing information. At the determined transmission timing of the I-frame, the video control unit 12b1 generates and outputs instruction information for reconstructing the GOP with the I-frame as a head.

[Operation S46] The video frame generation unit 12b2 generates a video frame by, for example, framing a camera video captured by a camera.

[Operation S47] The video encoder 12b3 encodes the video frame based on the instruction information, and transmits the encoded video frame (the video frame of the reconstructed GOP) to the radio transmission unit 11b2.

[Operation S48] The radio transmission unit 11b2 converts the video frame into a radio signal and transmits the radio signal to the base station 20-3.

[Operation S49] The radio reception unit 23b of the base station 20-3 converts the video frame transmitted from the transmission apparatus 10-3 into the electric signal. The data signal decoding unit 23b1 performs data signal decoding such as error correction from the converted electric signal, and transmits the video frame after the data signal decoding to the video server 30-3.

[Operation S49a] The video decoder 33b decodes the video frame (decoding, which is an inverse operation of the encoding by the video encoder 12b3) and transmits the decoded video data to the display apparatus 40 coupled to the video server 30-3.

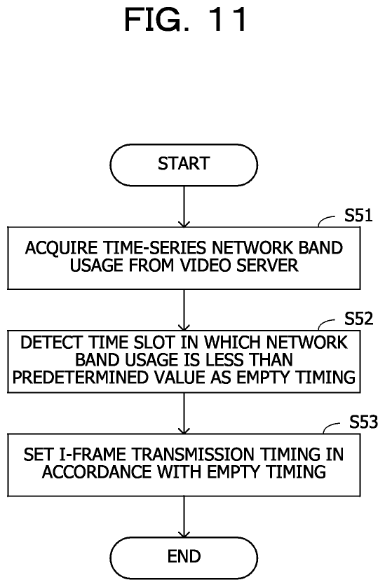

FIG. 11 is a flowchart illustrating an example of an operation of the transmission apparatus.

[Operation S51] The control unit 10b acquires a time-series network band usage from the video server 30-3 via the base station 20-3.

[Operation S52] The control unit 10b detects a time slot in which the network band usage is less than a predetermined value as an empty timing.

[Operation S53] The control unit 10b sets an I-frame transmission timing in accordance with the detected empty timing.

As described above, the control unit 10b monitors the network band usage of the network to which the transmission apparatus 10-3 and another transmission apparatus are coupled, detects a time slot in which the network band usage is less than a predetermined value, and sets a transmission timing of the I-frame in the detected time slot. Accordingly, in the transmission of the GOP reconstructed after the detection of the collision, it is possible to reduce a possibility that the I-frame transmission timings collide with each other again.

### Fourth Embodiment

According to a fourth embodiment, a collision between I-frame transmission timings is detected based on a transmission delay or a reception electric field intensity of a video frame.

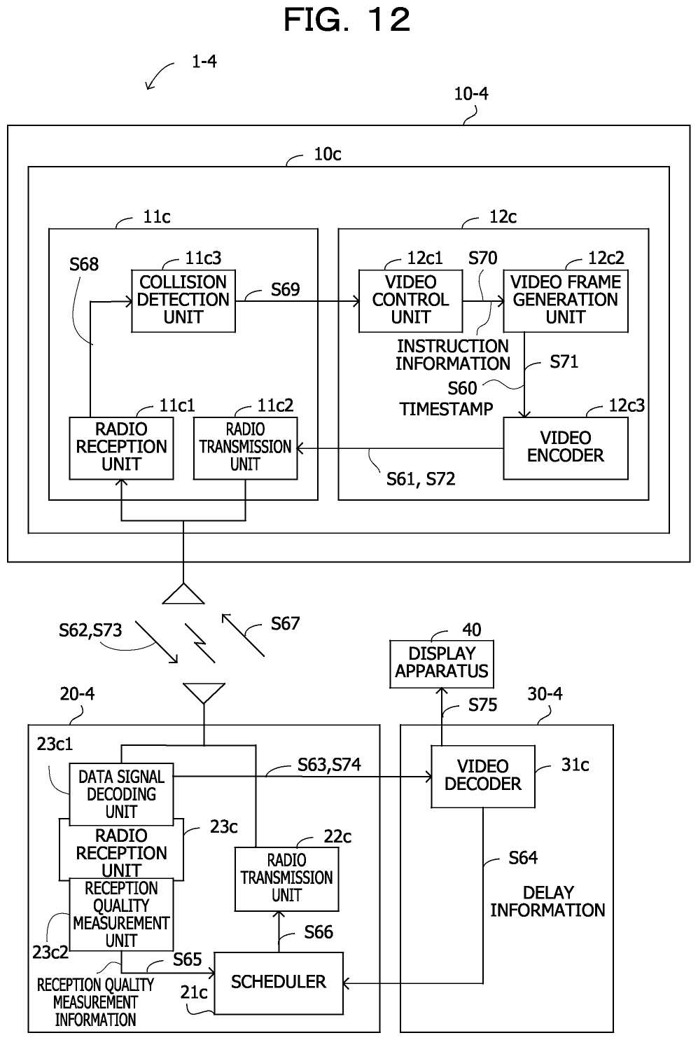

FIG. 12 is a diagram illustrating an example of a configuration of a transmission system. A transmission system 1-4 includes a transmission apparatus 10-4, a base station 20-4, and a video server 30-4.

The transmission apparatus 10-4 includes a control unit 10c, and the control unit 10c includes a radio unit 11c and a video unit 12c. The radio unit 11c includes a radio reception unit 11c1, a radio transmission unit 11c2, and a collision detection unit 11c3. The video unit 12c includes a video control unit 12c1, a video frame generation unit 12c2, and a video encoder 12c3.

The base station 20-4 includes a scheduler 21c, a radio transmission unit 22c, and a radio reception unit 23c, and the radio reception unit 23c has functions of a data signal decoding unit 23c1 and a reception quality measurement unit 23c2. The video server 30-4 includes a video decoder 31c.

[Operation S60] The video frame generation unit 12c2 adds a timestamp to a video frame and transmits the video frame to the video encoder 12c3.

[Operation S61] The video encoder 12c3 encodes the video frame, and transmits the encoded video frame and the timestamp to the radio transmission unit 11c2 of the transmission apparatus 10-4.

[Operation S62] The radio transmission unit 11c2 converts the video frame and the timestamp into a radio signal and transmits the radio signal to the base station 20-4.

[Operation S63] The radio reception unit 23c of the base station 20-4 converts the video frame and the timestamp transmitted from the transmission apparatus 10-4 into an electric signal. The data signal decoding unit 23c1 performs data signal decoding such as error correction from the converted electric signal, and transmits the video frame and the timestamp after the data signal decoding to the video server 30-4.

[Operation S64] The video decoder 31c generates delay information from a reception time of the received video frame and the timestamp (corresponding to a transmission time of the video frame from the transmission apparatus 10-4) added to the video frame, and transmits the delay information to the scheduler 21c.

[Operation S65] The reception quality measurement unit 23c2 measures the reception electric field intensity as the reception quality in the wireless communication for the transmission apparatus 10-4, and transmits reception quality measurement information that is the measurement result to the scheduler 21c.

[Operation S66] The scheduler 21c transmits the delay information and the reception quality measurement information to the radio transmission unit 22c.

[Operation S67] The radio transmission unit 22c converts the delay information and the reception quality measurement information into a radio signal and transmits the radio signal to the transmission apparatus 10-4.

[Operation S68] The radio reception unit 11c1 of the transmission apparatus 10-4 converts the delay information and the reception quality measurement information transmitted from the base station 20-4 into an electric signal, and transmits the delay information and the reception quality measurement information after the conversion into the electric signal to the collision detection unit 11c3.

[Operation S69] The collision detection unit 11c3 detects a collision between I-frame transmission timings based on the delay information and the reception quality measurement information, and outputs collision information.

[Operation S70] When the collision information is received, the video control unit 12c1 determines that a frame type of the video data scheduled to be transmitted as the I-frame is to be changed to the P-frame or the B-frame, and newly determines a transmission timing of the I-frame. At the determined transmission timing of the I-frame, the video control unit 12c1 generates and outputs instruction information for reconstructing the GOP with the I-frame as a head.

[Operation S71] For example, the video frame generation unit 12c2 generates and outputs a video frame by framing a camera video captured by a camera.

[Operation S72] The video encoder 12c3 encodes the video frame based on the instruction information, and transmits the encoded video frame (the video frame of the reconstructed GOP) to the radio transmission unit 11c2.

[Operation S73] The radio transmission unit 11c2 converts the video frame into a radio signal and transmits the radio signal to the base station 20-4.

[Operation S74] The radio reception unit 23c of the base station 20-4 converts video frame transmitted from the transmission apparatus 10-4 into an electric signal. The data signal decoding unit 23c1 performs data signal decoding such as error correction from the converted electric signal, and transmits the video frame after the data signal decoding to the video server 30-4.

[Operation S75] The video decoder 31c decodes the video frame and transmits the decoded video data to the display apparatus 40 coupled to the video server 30-4.

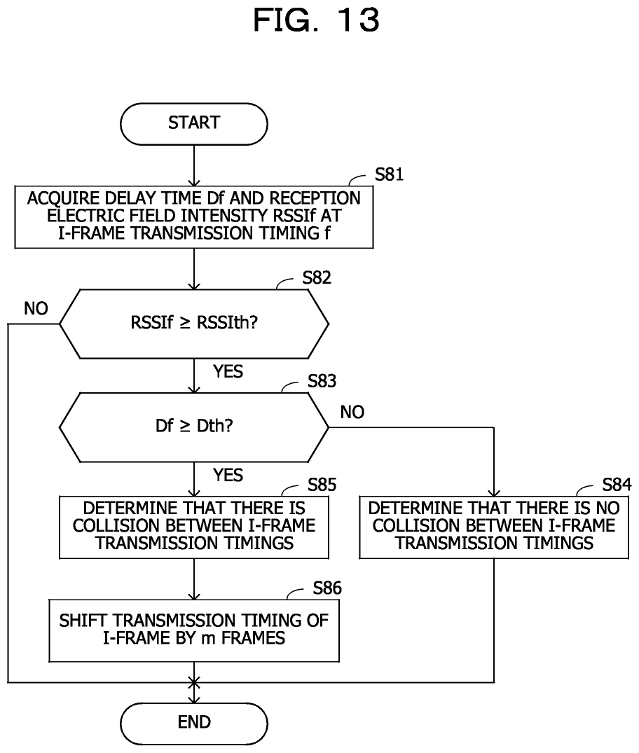

FIG. 13 is a flowchart illustrating an example of an operation of the transmission apparatus.

[Operation S81] The control unit 10c acquires a delay time Df and a reception electric field intensity RSSIf as a reception quality at an I-frame transmission timing f.

[Operation S82] The control unit 10c determines whether the reception electric field intensity RSSIf is equal to or greater than a threshold RSSIth (first threshold). In a case where the reception electric field intensity RSSIf is equal to or greater than the threshold RSSIth, the processing proceeds to operation S83, and in a case where the reception electric field intensity RSSIf is less than the threshold RSSIth, the processing ends.

[Operation S83] The control unit 10c determines whether the delay time Df is equal to or greater than a threshold Dth (second threshold). In a case where the delay time Df is equal to or greater than the threshold Dth, the processing proceeds to operation S85, and in a case where the delay time Df is less than the threshold Dth, the processing proceeds to operation S84.

[Operation S84] The control unit 10c determines that there is no collision between the I-frame transmission timings, and the processing ends.

[Operation S85] The control unit 10c determines that there is a collision between the I-frame transmission timings.

[Operation S86] The control unit 10c changes a frame type of video data scheduled to be transmitted as the I-frame, and accordingly shifts the I-frame transmission timing by m frames.

As described above, the control unit 10c measures a radio reception quality and a transmission delay with another transmission apparatus, and determines that the collision occurs between the I-frame transmission timings when the radio reception quality is equal to or greater than the first threshold and the transmission delay is equal to or greater than the second threshold. Accordingly, it is possible to accurately detect whether a collision occurs between the I-frame transmission timings.

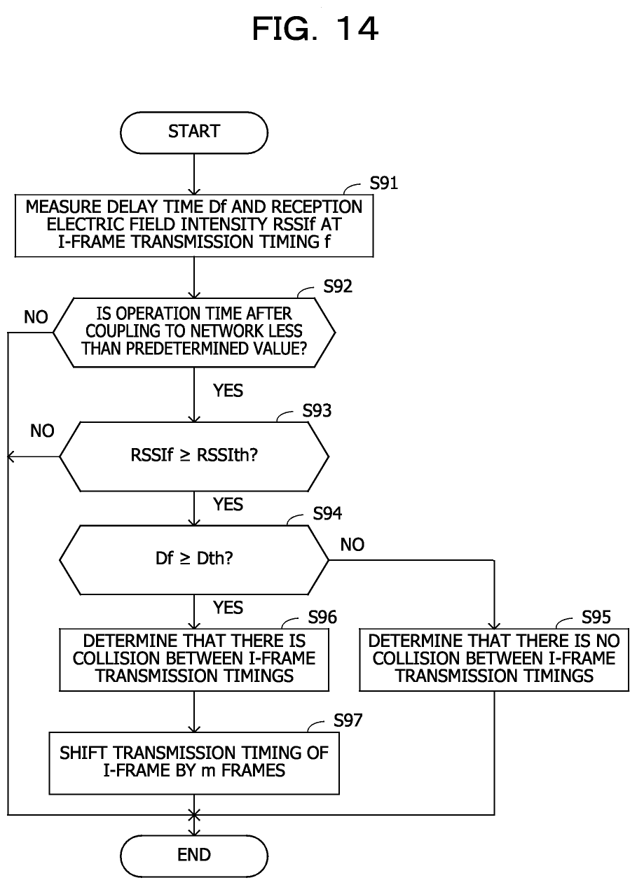

FIG. 14 is a flowchart illustrating an example of an operation of the transmission apparatus.

[Operation S91] The control unit 10c measures and acquires the delay time Df and the reception electric field intensity RSSIf at the I-frame transmission timing f.

[Operation S92] The control unit 10c determines whether an operation time after the transmission apparatus 10-4 is coupled to the network is less than a predetermined value. When the operation time is less than the predetermined value, the processing proceeds to operation S93, and when the operation time is equal to or greater than the predetermined value, the processing ends.

[Operation S93] The control unit 10c determines whether the reception electric field intensity RSSIf is equal to or greater than the threshold RSSIth. In a case where the reception electric field intensity RSSIf is equal to or greater than the threshold RSSIth, the processing proceeds to operation S94, and in a case where the reception electric field intensity RSSIf is less than the threshold RSSIth, the processing ends.

[Operation S94] The control unit 10c determines whether the delay time Df is equal to or greater than the threshold Dth. In a case where the delay time Df is equal to or greater than the threshold Dth, the processing proceeds to operation S96, and in a case where the delay time Df is less than the threshold Dth, the processing proceeds to operation S95.

[Operation S95] The control unit 10c determines that there is no collision between the I-frame transmission timings, and the processing ends.

[Operation S96] The control unit 10c determines that there is a collision between the I-frame transmission timings.

[Operation S97] The control unit 10c changes a frame type of video data scheduled to be transmitted as the I-frame, and accordingly shifts the I-frame transmission timing by m frames.

As described above, in a case where the operation time of the transmission apparatus 10-4 in the network in which the transmission apparatus 10-4 and another transmission apparatus are coupled is less than the predetermined value, the control unit 10c performs the measurement of the radio reception quality and the transmission delay after operation S93 described above, and determines whether a collision occurs between the I-frame transmission timings.

Accordingly, in a case where the collision occurs between the I-frame transmission timings, the transmission apparatus in which the operation time of the network communication is less than the predetermined value changes the I-frame transmission timing. Accordingly, the transmission apparatus in which the operation time is equal to or greater than the predetermined value may operate while maintaining the current control, and the stable operation of the system may be performed.

### Fifth Embodiment

According to a fifth embodiment, a transmission apparatus broadcasts a request for a time (offset time) for shifting the I-frame transmission timing to another transmission apparatus.

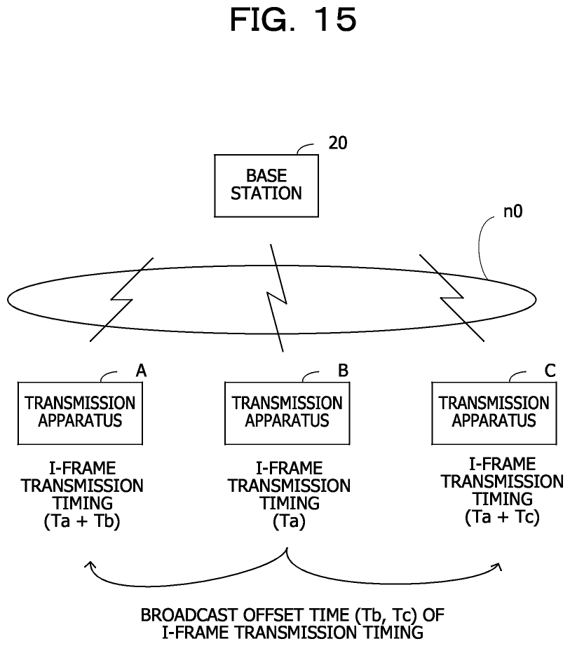

FIG. 15 is a diagram illustrating an example of a broadcast for indicating an offset time. Transmission apparatuses A, B, and C are wirelessly coupled to a base station 20 via a wireless network n0.

It is assumed that the transmission apparatus B detects a collision between the I-frame transmission timings. In this case, the transmission apparatus B broadcasts and notifies the transmission apparatuses A and C of the offset time of the I-frame transmission timing.

For example, the transmission apparatus B requests the transmission of an I-frame at a timing period of time Ta. The transmission apparatus B requests the transmission apparatus A to transmit an I-frame at a timing period of time Ta+Tb, and the transmission apparatus C to transmit an I-frame at a timing period of time Ta+Tc. For example, the transmission apparatus B broadcasts information including the offset time Tb for the transmission apparatus A and the offset time Tc for the transmission apparatus C.

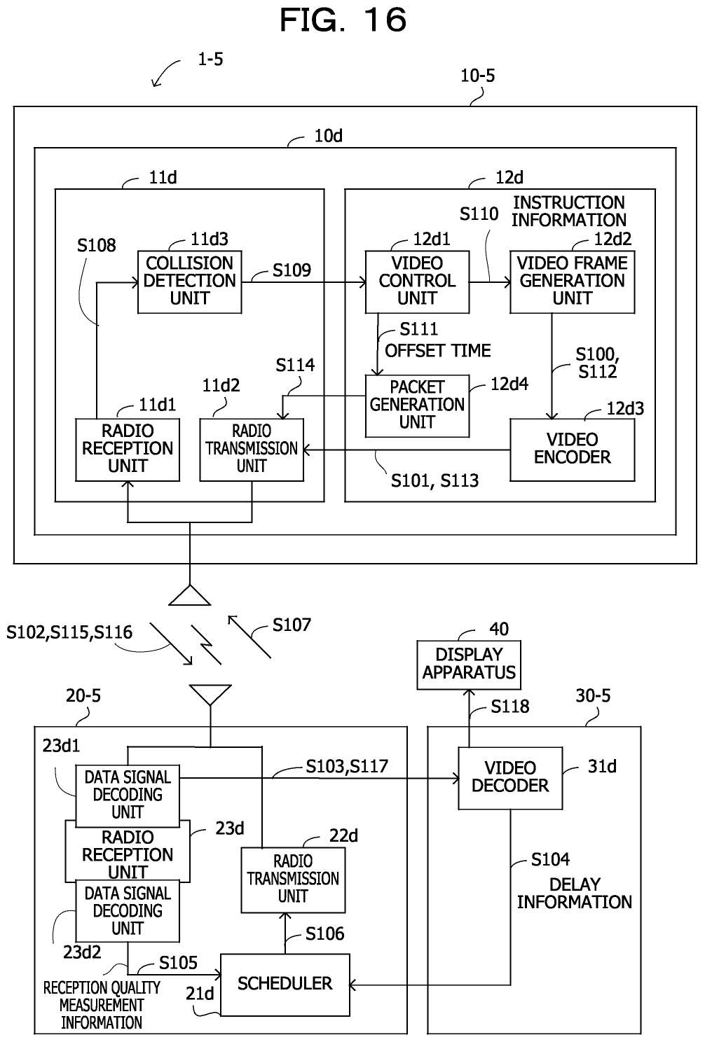

FIG. 16 is a diagram illustrating an example of a configuration of a transmission system. A transmission system 1-5 includes a transmission apparatus 10-5, a base station 20-5, and a video server 30-5.

The transmission apparatus 10-5 includes a control unit 10d, and the control unit 10d includes a radio unit 11d and a video unit 12d. The radio unit 11d includes a radio reception unit 11d1, a radio transmission unit 11d2, and a collision detection unit 11d3. The video unit 12d includes a video control unit 12d1, a video frame generation unit 12d2, a video encoder 12d3, and a packet generation unit 12d4.

The base station 20-5 includes a scheduler 21d, a radio transmission unit 22d, and a radio reception unit 23d, and the radio reception unit 23d has functions of a data signal decoding unit 23d1 and a reception quality measurement unit 23d2. The video server 30-5 includes a video decoder 31d.

[Operation S100] The video frame generation unit 12d2 adds a timestamp to a video frame and transmits the video frame to the video encoder 12d3.

[Operation S101] The video encoder 12d3 encodes the video frame, and transmits the encoded video frame and the timestamp to the radio transmission unit 11d2 of the transmission apparatus 10-5.

[Operation S102] The radio transmission unit 11d2 converts the video frame and the timestamp into a radio signal and transmits the radio signal to the base station 20-5.

[Operation S103] The radio reception unit 23d of the base station 20-5 converts the video frame and the timestamp transmitted from the transmission apparatus 10-5 into an electric signal. The data signal decoding unit 23d1 performs data signal decoding such as error correction from the converted electric signal, and transmits the video frame and the timestamp after the data signal decoding to the video server 30-5.

[Operation S104] The video decoder 31d generates delay information from a reception time of the received video frame and the timestamp (corresponding to a transmission time of the video frame from the transmission apparatus 10-5) added to the video frame, and transmits the delay information to the scheduler 21d.

[Operation S105] The reception quality measurement unit 23d2 measures a reception electric field intensity as a reception quality, and transmits reception quality measurement information that is the measurement result to the scheduler 21d.

[Operation S106] The scheduler 21d transmits the delay information and the reception quality measurement information to the radio transmission unit 22d.

[Operation S107] The radio transmission unit 22d converts the delay information and the reception quality measurement information into a radio signal and transmits the radio signal to the transmission apparatus 10-5.

[Operation S108] The radio reception unit 11d1 of the transmission apparatus 10-5 converts the delay information and the reception quality measurement information transmitted from the base station 20-5 into an electric signal, and transmits the delay information and the reception quality measurement information after the conversion into the electric signal to the collision detection unit 11d3.

[Operation S109] The collision detection unit 11d3 detects a collision between I-frame transmission timings from the delay information and the reception quality measurement information, and outputs collision information.

[Operation S110] When the collision information is received, the video control unit 12d1 determines that a frame type of the video data scheduled to be transmitted as the I-frame is to be changed to the P-frame or the B-frame, and newly determines a transmission timing of the I-frame. At the determined transmission timing of the I-frame, the video control unit 12d1 generates and outputs instruction information for reconstructing the GOP with the I-frame as a head.

[Operation S111] The video control unit 12d1 determines and outputs an offset time of the I-frame transmission timing to another transmission apparatus.

[Operation S112] For example, the video frame generation unit 12d2 generates and outputs a video frame by framing a camera video captured by a camera.

[Operation S113] The video encoder 12d3 encodes the video frame based on the instruction information, and transmits the encoded video frame (the video frame of the reconstructed GOP) to the radio transmission unit 11d2.

[Operation S114] The packet generation unit 12d4 generates a packet for a broadcast including the offset time and transmits the packet to the radio transmission unit 11d2.

[Operation S115] The radio transmission unit 11d2 converts the video frame into a radio signal and transmits the radio signal to the base station 20-5.

[Operation S116] The radio transmission unit 11d2 broadcasts the packet including the offset time.

[Operation S117] The radio reception unit 23d of the base station 20-5 converts the video frame transmitted from the transmission apparatus 10-5 into an electric signal. The data signal decoding unit 23d1 performs data signal decoding such as error correction from the converted electric signal, and transmits the video frame after the data signal decoding to the video server 30-5.

[Operation S118] The video decoder 31d decodes the video frame and transmits the decoded video frame to the display apparatus 40 coupled to the video server 30-5.

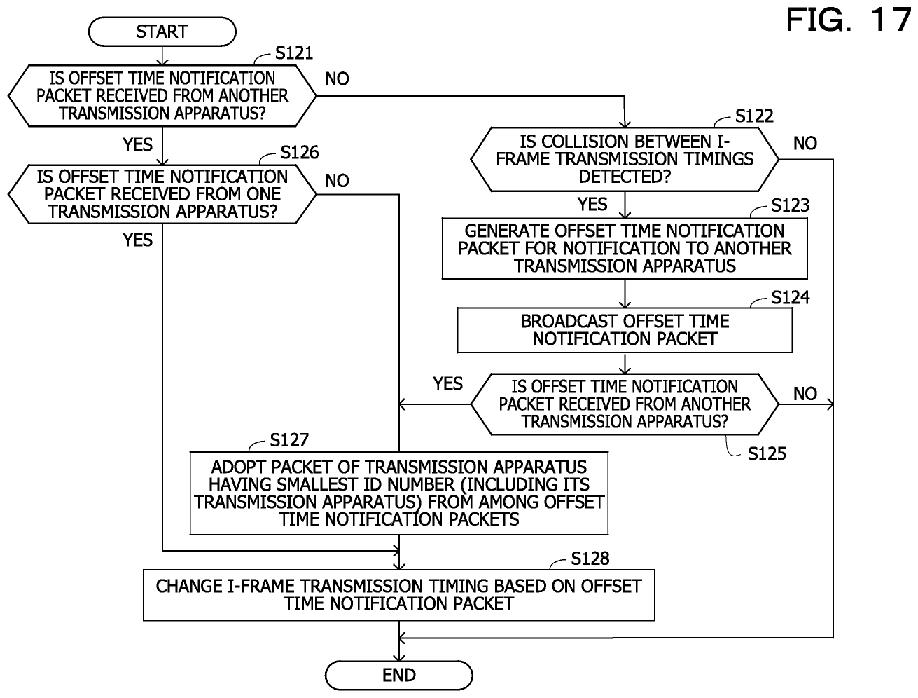

FIG. 17 is a flowchart illustrating an example of an operation of the transmission apparatus.

[Operation S121] The control unit 10d determines whether the packet (offset time notification packet) including the offset time of the I-frame transmission timing is received from another transmission apparatus. In a case where the offset time notification packet is not received, the processing proceeds to operation S122, and in a case where the offset time notification packet is received, the processing proceeds to operation S126.

[Operation S122] The control unit 10d determines whether a collision between I-frame transmission timings is detected. In a case where a collision is detected, the processing proceeds to operation S123, and in a case where a collision is not detected, the processing ends.

[Operation S123] The control unit 10d generates an offset time notification packet for notifying another transmission apparatus of the offset time.

[Operation S124] The control unit 10d broadcasts the offset time notification packet.

[Operation S125] The control unit 10d determines whether the offset time notification packet is received from another transmission apparatus. In a case where the offset time notification packet is received, the processing proceeds to operation S127, and in a case where the offset time notification packet is not received, the processing ends.

[Operation S126] The control unit 10d determines whether the offset time notification packet is received from one transmission apparatus. In a case where the offset time notification packet is not received from one transmission apparatus (offset time notification packets are received from a plurality of transmission apparatuses), the processing proceeds to operation S127, and in a case where the offset time notification packet is received from one transmission apparatus, the processing proceeds to operation S128.

[Operation S127] The control unit 10d adopts the offset time indicated in the offset time notification packet transmitted from a transmission apparatus having a smallest ID number including the transmission apparatus 10-5, for example, from among the received offset time notification packets.

[Operation S128] The control unit 10d changes the I-frame transmission timing based on the offset time notification packet.

As described above, in a case where the I-frame is transmitted from the transmission apparatus 10-5 at a first transmission timing after the detection of the collision, the control unit 10d notifies another transmission apparatus of the offset time shifted by a time that does not overlap the first transmission timing. The control unit 10d causes another transmission apparatus to transmit an I-frame at a second transmission timing shifted by the offset time from the first transmission timing.

Accordingly, since the offset time may be recognized between the plurality of transmission apparatuses that perform video transmission, it is possible to accurately establish the transmission timing at which the I-frame transmission timings do not collide with each other with respect to the opposing transmission apparatuses in the same wireless network.

The transmission apparatus according to an embodiment of the present disclosure described above may be implemented by a computer. In this case, a program in which a content of processing of functions to be included in the transmission apparatus is described is provided. By executing the program on the computer, the processing functions described above is implemented over the computer.

The program in which the content of processing is described may be recorded in a computer-readable recording medium. Examples of the computer-readable recording medium include a magnetic storage unit, an optical disk, a magneto-optical recording medium, a semiconductor memory, and the like. Examples of the magnetic storage unit include a hard disk device (HDD), a flexible disk (FD), a magnetic tape, and the like. Examples of the optical disk include a CD-ROM/RW and the like. Examples of the magneto optical recording medium include a magneto-optical (MO) disk and the like.

In a case where the program is to be distributed, for example, a portable-type recording medium such as a CD-ROM in which the program is recorded is sold. The program may be stored in a storage unit of a server computer and transferred from the server computer to another computer via a network.

For example, the computer executing the program stores, in a storage unit thereof, the program recorded in the portable-type recording medium or the program transferred from the server computer. The computer reads the program from the storage unit thereof and executes the processing in accordance with the program. The computer may read the program directly from the portable-type recording medium and execute the processing in accordance with the program.

Each time the program is transferred from the server computer coupled via the network to the computer, the computer may sequentially execute processing in accordance with the received program. At least a part of the above-described processing functions may be implemented by using an electronic circuit such as the DSP, the ASIC, and the PLD.

The embodiments have been described above. However, the configuration of each unit illustrated in the embodiments may be replaced with another unit having the similar function. Arbitrary other elements and processes may be added. Two or more arbitrary configurations (features) out of the above-described embodiments may be combined together.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a transmission program causing a computer of a first transmission apparatus to execute a procedure, the procedure comprising:
detecting a collision between a transmission timing of an intra-coded video frame in first video data transmitted from the first transmission apparatus and a transmission timing of an intra-coded video frame in second video data transmitted from a second transmission apparatus;
changing, when the collision is detected at a first time, a frame type of the first video data to one of a forward predictive coded video frame and a bi-directional predictive coded video frame; and
transmitting the first video data of which the frame type is changed, at a second time at which the intra-coded video frame in the first video data is scheduled to be transmitted.

2. The non-transitory computer-readable recording medium according to claim 1, wherein the procedure further comprising:
changing the transmission timing of the intra-coded video frame in the first video data after the detection of the collision; and
reconstructing a group of pictures (GOP) in which the changed intra-coded video frame in the first video data as a head, the forward predictive coded video frame, and the bi-directional predictive coded video frame are included.

3. The non-transitory computer-readable recording medium according to claim 1, wherein the procedure
changes the frame type of the first video data to the bi-directional predictive coded video frame in a case where a compression rate after the change of the frame type is to be increased than a compression rate before the change of the frame type, and
changes the frame type of the first video data to the forward predictive coded video frame in a case where an image quality after the change of the frame type is not to be decreased than an image quality before the change of the frame type.

4. The non-transitory computer-readable recording medium according to claim 1, the procedure further comprising:
monitoring a band usage of a network coupled to the second transmission apparatus;
detecting a time slot in which the band usage is less than a predetermined value; and
transmitting the first video data in which the intra-coded video frame is included in the detected time slot.

5. The non-transitory computer-readable recording medium according to claim 1, the procedure further comprising:
measuring a radio reception quality and a transmission delay with the second transmission apparatus at the transmission timing of the intra-coded video frame in the first video data; and
determining that the collision occurs in a case where the radio reception quality is equal to or greater than a first predetermined value and the transmission delay is equal to or greater than a second predetermined value.

6. The non-transitory computer-readable recording medium according to claim 5, wherein the procedure further comprising:
measuring the radio reception quality and the transmission delay between the first transmission apparatus and the second transmission apparatus in a case where an operation time in the network coupled to the second transmission apparatus is less than a third predetermined value.

7. The non-transitory computer-readable recording medium according to claim 1, the procedure further comprising:
in a case where the intra-coded video frame in the first video data is transmitted at a first transmission timing after the detection of the collision,
notifying the second transmission apparatus of an offset time shifted by a time that does not overlap the first transmission timing; and
causing the second transmission apparatus to transmit the intra-coded video frame in the second video data at a second transmission timing shifted by the offset time from the first transmission timing.

8. A transmission apparatus comprising:
a memory; and
a processor coupled to the memory and configured to:
detect a collision between a transmission timing of an intra-coded video frame in first video data transmitted from the transmission apparatus and a transmission timing of an intra-coded video frame in second video data transmitted from an other transmission apparatus;
change, when the collision is detected at a first time, a frame type of the first video data to one of a forward predictive coded video frame and a bi-directional predictive coded video frame; and
transmit the first video data of which the frame type is changed, at a second time at which the intra-coded video frame in the first video data is scheduled to be transmitted.

9. A transmission method for causing a computer of a first transmission apparatus to execute a procedure, the procedure comprising:
detecting a collision between a transmission timing of an intra-coded video frame in first video data transmitted from the first transmission apparatus and a transmission timing of an intra-coded video frame in second video data transmitted from a second transmission apparatus;
changing, when the collision is detected at a first time, a frame type of the first video data to one of a forward predictive coded video frame and a bi-directional predictive coded video frame; and
transmitting the first video data of which the frame type is changed, at a second time at which the intra-coded video frame in the first video data is scheduled to be transmitted.
